(19) United States
(12) Patent Application Publication
(10) Pub. No.: US 2005/0080866 A1
(43) Pub. Date: Apr. 14, 2005

(54) Selectively displaying time indications for instant messaging (IM) messages

(76) Inventors: Larry G. Kent JR., Loganville, GA (US); Dale W. Malik, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/685,626

(22) Filed: Oct. 14, 2003

(51) Int. Cl. G06F 15/16

(52) U.S. Cl. 709/207

(57) ABSTRACT

The present disclosure provides enhanced IM time-stamping capabilities. As such, some embodiments provide for selectively displaying a time indication in response to various triggering events.

### FIELD OF THE INVENTION

The present disclosure relates generally to digital communications and, more particularly, to instant messaging.

### BACKGROUND

Instant messaging (IM) systems permit near real-time communications between users. Typically, the near real-time communications include text messaging, voice chat, and video conferencing. A majority of the time, IM communications are used for text messaging. FIGS. 1 and 2 show examples of IM communications between a user and a contact.

As shown in FIG. 1, during text IM, the user types a text message in an input area 110 to a contact. Thereafter, the contact may reply to the user's text message. This back-and-forth exchange of text messages is often displayed in a dialogue box 105 at an IM chat window 100a, with the most-recently-displayed message 120 typically being displayed at the bottom of the IM messages 115. Hence, both the user and the contact may follow the history of the conversation by viewing the IM messages 115 displayed in the dialogue box 105. As is known, the IM chat window 100a may include a scroll bar 160 that permits the user to scroll portions of the IM messages 115 that may have moved beyond the visible area of the dialogue box 105, as the user and the contact exchange IM messages 115.

As is known to those of skill in the art, the IM chat window 100a may also include various function bars 130, 125 that include icons, such as, color selection icons 135 that permit the user to change the foreground and background color of the dialogue box 105, font size manipulation icons 140 that permit the user to change the font size of the text, font type manipulation icons 145 that permit the user to change the font size, a uniform resource locator (URL) icon 150 that permits the user to send URL information, an emoticon icon 155 that permits the user to display a variety of emoticons (e.g., smiley faces, sad faces, etc.), a speaker icon 165 that permits the user to turn on or off incoming audio streams, an add-contact icon 170 that permits the user to add the contact to the user's IM contact list, a block icon 175 that permits the user to block or ignore the IM contact, an IM history icon 180 that permits the user to begin or end logging the IM chat session, a contact information icon 185 that permits the user to obtain additional information about the contact, and other icons that perform a variety of other IM functions.

As described above, the exchanged text messages 115 are often displayed to the user in a dialogue box 105 at the IM chat window 100a. In addition to seeing the exchanged text messages 115, it is sometimes desirable to see the time at which each text message 115 was sent or displayed to the user and the contact. Thus, IM clients often provide a mechanism by which time stamps appear adjacent to their respective IM messages. An example of such a system is shown in FIG. 2.

As shown in FIG. 2, when the option to display the time stamps is turned on, each text message 215 also displays a corresponding time stamp 225 adjacent to the text message 215. For example, in FIG. 2, the time stamps 225 show that the user typed a text message 215 that was displayed at 09:22 on Jul. 1, 2003, and the contact replied with a text message 220 that was displayed at 09:23 on Jul. 1, 2003. As seen from FIG. 2, each text message displays a time stamp 225, thereby cluttering the dialogue box 205 with a plethora of time stamps. In order to reduce the clutter, the user may turn off the option to display the time stamps 225. However, turning off the time-stamping option results in the removal of all time stamps 225 from the dialogue box 205. Hence, the user is often limited to displaying all time stamps 225, or not displaying any time stamp 225 at all. Additionally, in order for the user to activate or deactivate the time-stamping feature, the user must typically select these options manually.

In view of these deficiencies, a heretofore-unaddressed need exists in the industry to improve the time-stamping functionality associated with IM.

### SUMMARY

The present disclosure provides enhanced IM time-stamping capabilities. As such, some embodiments, among others, provide for displaying instant messaging (IM) messages, and selectively displaying a time indication. The time indication is indicative of a most-recently-displayed IM message.

Other embodiments provide for displaying a first instant messaging (IM) message, calculating an elapsed time from the displaying of the first IM message, determining whether a second IM message has been displayed within the elapsed time, and displaying a first time indication. The first time indication is associated with the first IM message. Additionally, the first time indication is displayed in response to determining that the second IM message has not been displayed within the elapsed time.

Yet other embodiments provide for detecting a triggering event associated with an IM chat session, and displaying a visual indicator in response to the triggering event.

Other devices, systems, methods, features, and advantages will be or become apparent to one with skill in the art upon examination of the following drawings and detailed description. It is intended that all such additional systems, methods, features, and advantages be included within this description.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a diagram showing an instant messaging (IM) chat window of prior approaches, in which no time stamps are displayed.

FIG. 2 is a diagram showing an IM chat window found in prior approaches, in which a time stamp is displayed for each IM message line.

FIG. 3 is a diagram showing an embodiment of an IM chat window adapted to selectively display a time indication for a specific IM message line.

FIG. 4 is a diagram showing an embodiment of an IM chat window adapted to selectively display time stamps for specific IM message lines.

FIG. 5 is a diagram showing an embodiment of an IM chat window adapted to selectively display time indications for specific IM message lines.

FIG. 6 is a diagram showing another embodiment of an IM chat window adapted to selectively display time indications for specific IM message lines.

FIG. 7 is a block diagram showing an embodiment of a system configured to generate the IM chat windows of FIGS. 1 through 6.

FIG. 8 is a block diagram showing an embodiment of component architecture associated with the system of FIG. 7.

FIG. 9 is a block diagram showing, in greater detail, an embodiment of the IM client of FIGS. 7 and 8.

FIG. 10 is a flowchart showing an embodiment of a method for selectively displaying time indications for specific IM message lines.

FIG. 11 is a flowchart showing another embodiment of a method for selectively displaying time indications for specific IM message lines.

FIG. 12 is a flowchart showing yet another embodiment of a method for selectively displaying time indications for specific IM message lines.

FIG. 13 is a flowchart showing, in greater detail, the step of determining the existence of a triggering event from FIG. 12.

FIG. 14 is a flowchart showing, in greater detail, the step of displaying the time associated with the triggering event of FIG. 12.

### DETAILED DESCRIPTION OF THE PREFERRED EMBODIMENTS

Reference is now made in detail to the description of the embodiments as illustrated in the drawings. While several embodiments are described in connection with these drawings, there is no intent to limit the invention to the embodiment or embodiments disclosed herein. On the contrary, the intent is to cover all alternatives, modifications, and equivalents.

The embodiments below describe enhancements to IM time-stamping functions. Unlike prior approaches in which IM time stamps were either provided for every displayed IM message or not provided for any displayed IM message, the embodiments below provide systems and methods in which time stamps are selectively provided for specific IM messages. For example, in some embodiments, a time stamp is provided for only the most-recently-displayed IM message, thereby reducing visible clutter associated with the prior systems that displayed time stamps for all IM messages. In other embodiments, time stamps are provided when certain triggering events occur. Non-limiting examples of such triggering events may include, but are not limited to, an initiation of an IM chat session, an extended period of inactivity at an IM chat window, a continuation of an IM chat session after a predefined period of inactivity at an IM chat window, a change in the user's IM status, a change in the contact's IM status, and/or a combination of these events. Thus, unlike prior approaches, which often required users to manually enable or disable IM time stamping, the systems and methods described below provide automatic approaches to IM time stamping.

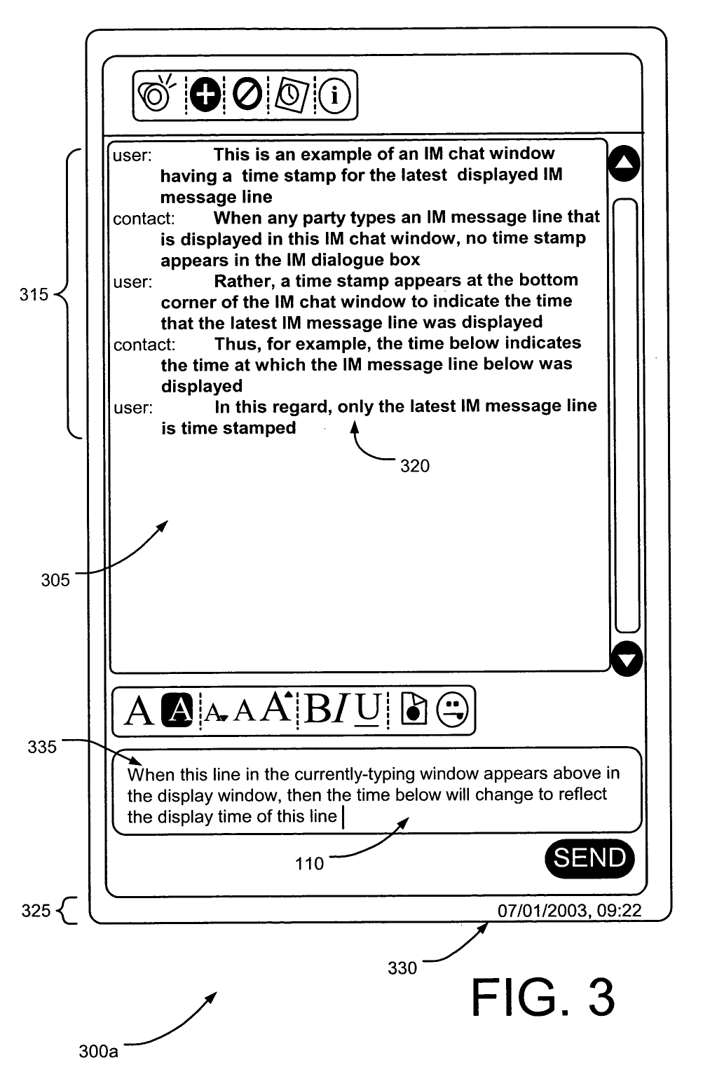

FIG. 3 is a diagram showing an embodiment of an IM chat window 300a adapted to selectively display time indications for specific IM message lines. As shown in FIG. 3, some embodiments of the IM chat window 300a include an IM dialogue box 305, which visually displays the IM messages 315 to the user. The most-recently-displayed IM message 320 appears at the bottom of the IM messages 315. Hence, a currently-typed text 335 that is entered at an input area 110 will, when eventually displayed, appear as the most-recently-displayed IM message 320, thereby resulting in an upward scrolling of the displayed IM messages 315 when the dialogue box 305 is filled with displayed IM messages 315.

In some embodiments, the IM chat window 300a includes a status bar 325, which may be located at the bottom of the IM chat window 300a. The status bar 325 includes a most-recently-displayed IM time 330, which indicates the time at which the most-recently-displayed IM message 320 is displayed to the user. In this regard, when the currently-typed text 335 is eventually displayed in the IM dialogue box 305, the most-recently-displayed IM time 330 will be updated to reflect the time at which the most-recently-displayed IM message 320 is displayed to the user.

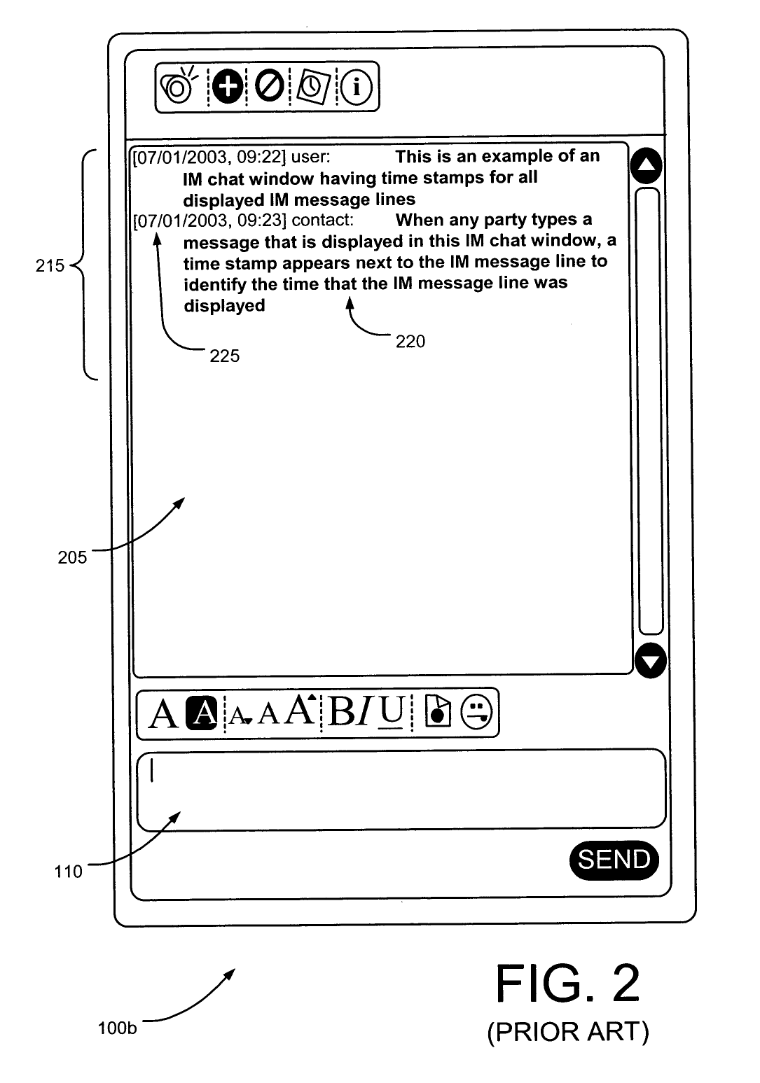

As shown in the embodiment of FIG. 3, by providing a time indication for only the most-recently-displayed IM message 320, much of the clutter from FIG. 2 is removed, and a more elegant time indication is provided to the user.

In addition to the embodiment described above, it should be appreciated that there may be other approaches to minimizing visual clutter in the IM chat window. For example, visual clutter may be reduced by hiding the time indications for the IM message lines and selectively displaying the time indication upon placing a cursor over a given IM message line. For example, each IM message line 315 may include a hidden time indication that becomes visible when a cursor is placed over the IM message line 315 (e.g., “hover over” functionality known in the art). Similarly, each IM message line 315 may include a hidden time indication that becomes visible when a user selects a particular IM message line 315 using, for example, a mouse or other pointing device (e.g., using “right-click” or “left-click” of a mouse button). Since features such as hover, right-click, and left-click are known in the art, further discussion of techniques for selecting a particular IM message line 315 is omitted here.

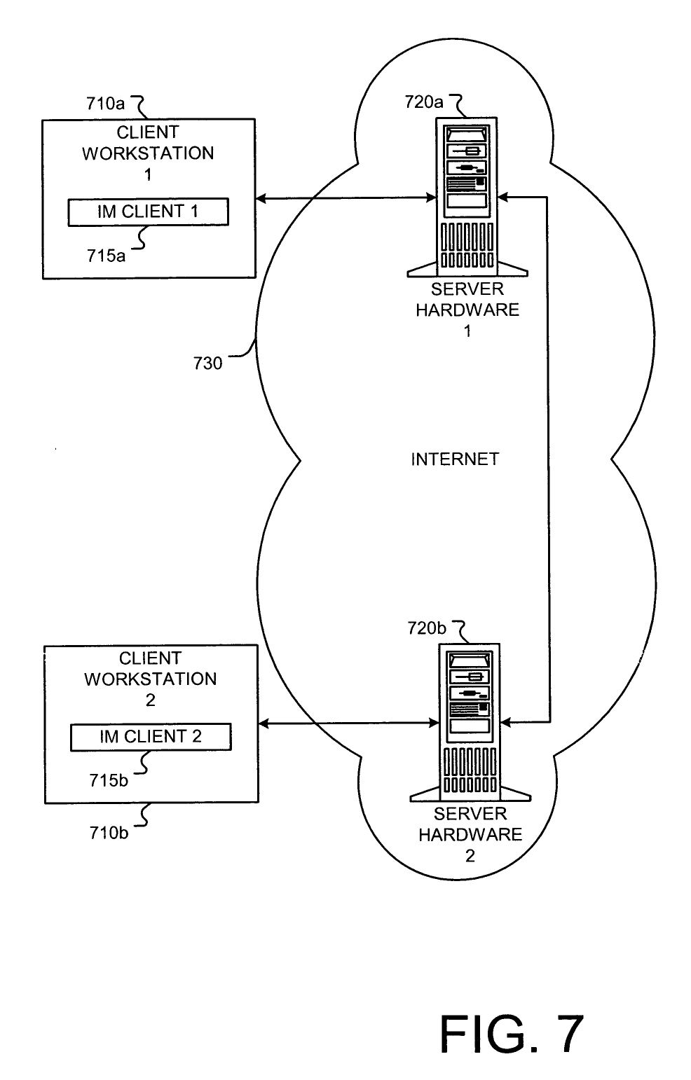

Embodiments of systems and methods for implementing the most-recently-displayed IM time 330 are described below with reference to FIGS. 7 through 14.

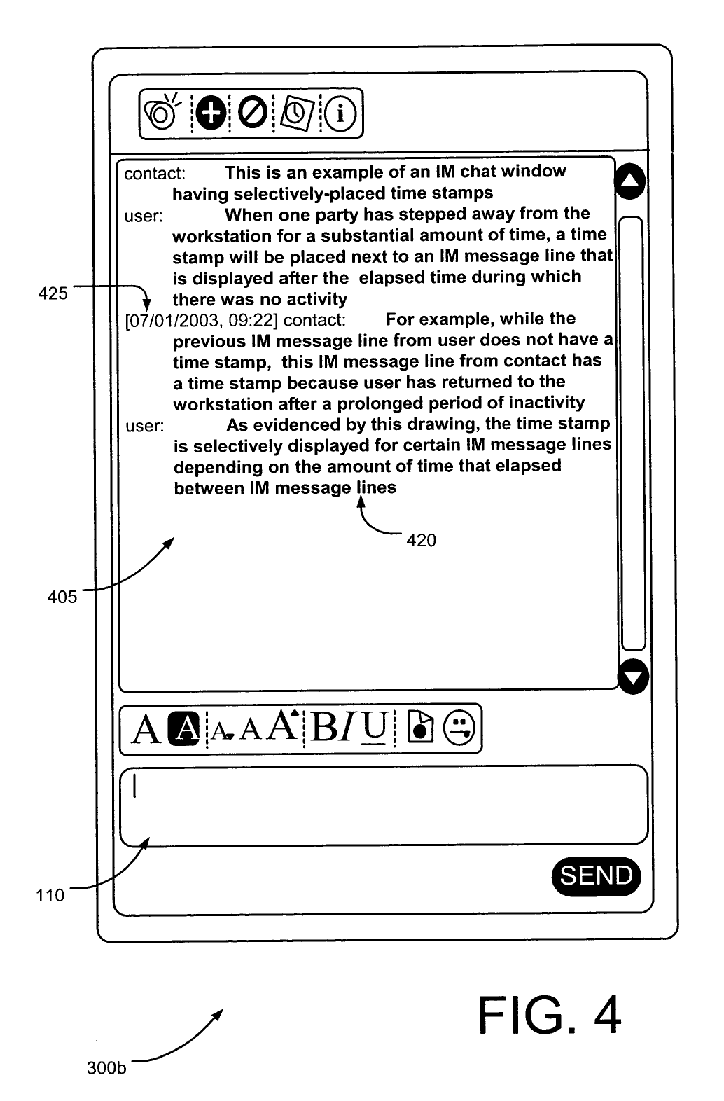

FIG. 4 is a diagram showing an embodiment of an IM chat window 300b adapted to selectively display time indications for specific IM message lines. As shown in FIG. 4, some embodiments of the IM chat window 300b include an IM dialogue box 405, which visually displays the IM messages to the user. The most-recently-displayed IM message 420 appears at the bottom of the IM messages.

In some embodiments, the IM chat window 300b displays an inactivity IM time stamp 425, which is indicative of a time at which there has been inactivity at the IM chat window 300b. In this regard, when a contact sends an IM message to the user, and there is no activity at the IM chat window 300b for a predefined time period, then the inactivity IM time stamp 425 informs the user of the time at which the contact last sent the IM message. In other words, the inactivity IM time stamp 425 informs the user of the time of onset of the inactivity. The predefined time period may be a default time period, such as, for example, five (5) minutes or ten (10) minutes, that is hard-coded into IM client. Alternatively, the predefined time period may be user-configurable, in which case an IM user may set the predefined time to a time interval ranging from several seconds to several minutes, hours, or even days.

As shown in the embodiment of FIG. 4, by providing an inactivity IM time stamp 425 after a predefined period of inactivity, a user may track the times of inactivity during the IM chat session. Unlike the embodiment of FIG. 3, the embodiment of FIG. 4 displays time information for select IM messages that may not be the most-recently-displayed IM message 420. It should, however, be appreciated that the embodiment of FIG. 3 and the embodiment of FIG. 4 may be combined so that the inactivity IM time stamp 425 is displayed in the dialogue box 405 while the most-recently-displayed IM time 330 is displayed in a status bar 325. Embodiments of systems and methods for implementing the inactivity IM time stamp 425 are described below with reference to FIGS. 7 through 14.

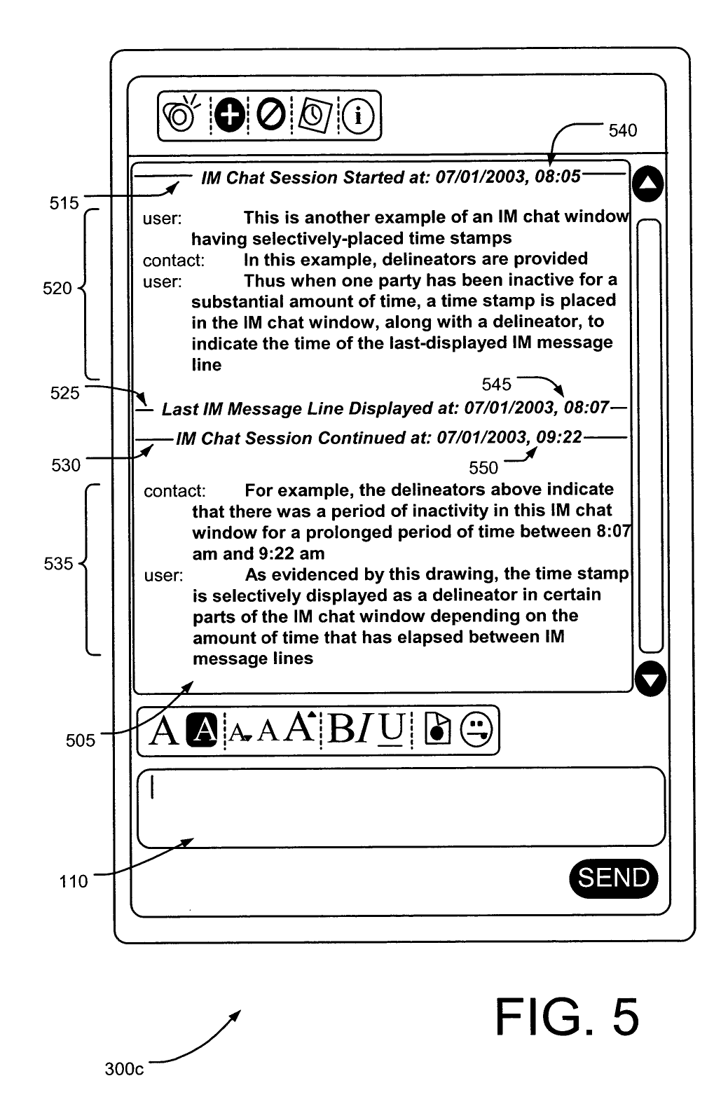

FIG. 5 is a diagram showing another embodiment of an IM chat window 300c adapted to selectively display time indications 540, 545, 550 for specific IM message lines. As shown in FIG. 5, some embodiments of the IM chat window 300c include an IM dialogue box 505, which visually displays the IM messages 520, 530 to the user.

In some embodiments, the IM dialogue box 505 displays visual delineators 515, 524, 530, which visually depict the occurrence of various events, such as, for example, chat session initiation, inactivity, continued activity after a period of inactivity, or other predefined events. Thus, in some embodiments, when an IM chat session is initiated, an initial visual delineator 515 may be displayed in the IM chat window 300c. The initial visual delineator 515 may include an initial IM time indication 540, which provides a start time for the IM chat session. In other embodiments, the initial IM time indication 540 may be displayed without the initial visual delineator 515, or vice versa. In the embodiment of FIG. 5, the initial IM time indication 540 shows that the IM chat session started at 08:05 on Jul. 1, 2003.

After displaying the initial IM time indication 540 and/or the initial visual delineator 515, IM messages 520 from the user and the contact are displayed in the IM dialogue box 505. In some embodiments, an inactivity visual delineator 525 is displayed in the IM dialogue box 505, in the event of inactivity in the IM chat window 300c. The inactivity visual delineator 525 may include an inactivity IM time indication 545, which is indicative of a time of onset of inactivity at the IM chat window 300c. In this regard, when a contact sends an IM message to the user, and there is no activity at the IM chat window 300c for a predefined time period, then the inactivity IM time indication 545 informs the user of the time at which the contact last sent the IM message. In other words, the inactivity IM time indication 545 provides information related to inactivity at the IM chat window 300c. In the embodiment of FIG. 5, the inactivity IM time indication 545 shows that the onset of inactivity in the IM chat session was at 08:07 on Jul. 1, 2003.

In some embodiments, when activity resumes at the IM chat window 300c, a continued-activity visual delineator 530 may be displayed in the IM dialogue box 505. The continued-activity visual delineator 530 may include a continued-activity IM time indication 550, which is indicative of a time at which IM activity continues at the IM chat window 300c. In this regard, if there is continued activity after a predefined period of inactivity, then the continued-activity IM time indication 550 informs the user of the onset of the continued activity. In the embodiment of FIG. 5, the continued-activity IM time indication 550 shows that, after a period of inactivity from 08:07, activity continued at 09:22 on Jul. 1, 2003.

While not shown in FIG. 5, it should be appreciated that a time indication may also be provided for when an IM chat session terminates. For example, when a user closes an IM chat window, a mechanism may be implemented to query the user on whether or not the user wishes to have a termination time indication recorded in an IM chat log. In some embodiments, the query mechanism may be a user-selectable icon that appears on the screen, which provides the option to the user to save the termination time. Since IM chat logs and user-selectable icons are known in the art, further discussion of IM chat logs and user-selectable icons is omitted.

As shown in the embodiment of FIG. 5, information may be available to an IM user without visual clutter by providing time indications that are dependent on various triggering events (e.g., initiation of IM chat session, predefined period of inactivity, continued activity after a period of inactivity, etc.). Unlike the embodiments of FIGS. 3 and 4, which provide limited information to the user, the embodiment of FIG. 5 displays additional information in the IM dialogue box 505 for various triggering events.

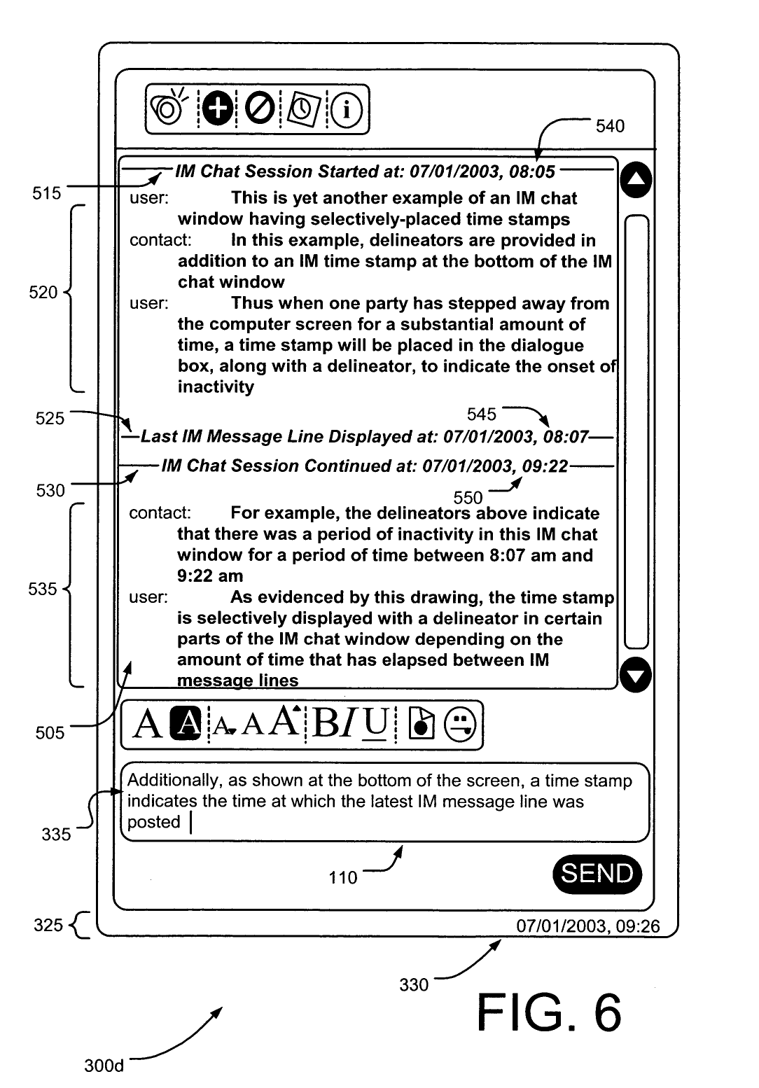

FIG. 6 is a diagram showing yet another embodiment of an IM chat window 300d adapted to selectively display time indications for specific IM messages. Specifically, FIG. 6 shows an embodiment having the combined features of FIG. 3 and FIG. 5. As shown in FIG. 6, some embodiments of the IM chat window 300d include an IM dialogue box 505, which visually displays the IM messages 520, 530 to the user, and a status bar 325, which visually displays a most-recently-displayed IM time 330.

As described with reference to FIG. 5, the IM dialogue box 505 may display visual delineators 515, 524, 530 and time indications 540, 545, 550, which visually depict the time of occurrence for various events. The various events may include, for example, chat session initiation, inactivity, continued activity after a period of inactivity, or other predefined events. Additionally, the IM chat window 300d includes a status bar 325 that includes a most-recently-displayed IM time 330. In this regard, when the currently-typed text 335 is eventually displayed in the IM dialogue box 505, the most-recently-displayed IM time 330 will be updated to reflect the time at which the most-recently-displayed IM message 320 is displayed to the user.

Similar to the embodiment of FIG. 5, a termination indication may also be included in the embodiment of FIG. 6. In addition to the termination indication, an IM thread history may also be included, thereby permitting a continuation of a previously-engaged IM chat session. Thus, the visual indicators of FIGS. 5 and 6 may also be indicative of a continued IM chat session from a previously-engaged IM chat session. For example, if a user terminates an IM chat session, and a thread for the IM chat session is stored, then a mechanism may be implemented in which the user is queried, at the initiation of another IM chat session, to determine whether or not the newly-initiated IM chat session is a continued IM chat session of the previously-terminated IM chat session. The query mechanism may be a user-selectable icon that is implemented using known mechanisms. Since threading of IM chat sessions is discussed in greater detail in U.S. patent application Ser. No. 10/326,479, which is incorporated herein by reference as if set forth in its entirety, further discussion of IM chat session threading is omitted here.

As demonstrated by the embodiment of FIG. 6, the several embodiments of FIGS. 3 through 5 may be combined in different permutations to selectively provide IM time information to the user.

The embodiments of FIGS. 3 through 6 provide for an enhanced IM environment in which time information is available to the user without the clutter that existed in prior systems and methods. Additionally, unlike prior approaches, the time indications may be displayed in response to a triggering event, thereby relieving the user from manually toggling on and off the IM time-stamping functionality at an IM client.

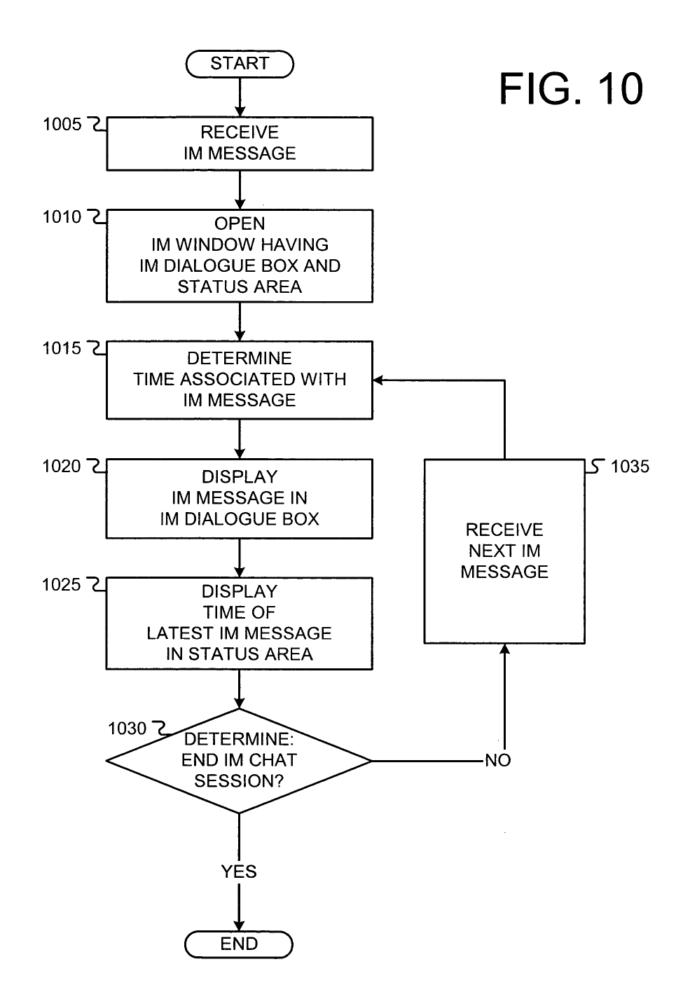

Having described several embodiments of IM chat windows 300, attention is turned to FIGS. 7 through 14, which show other embodiments that may be configured to implement the IM time-stamping functionality described with reference to FIGS. 3 through 6. FIGS. 7 through 9 show embodiments of systems for implementing the above-described IM time-stamping functionality, while FIGS. 10 through 14 show embodiments of methods for implementing the above-described IM time-stamping.

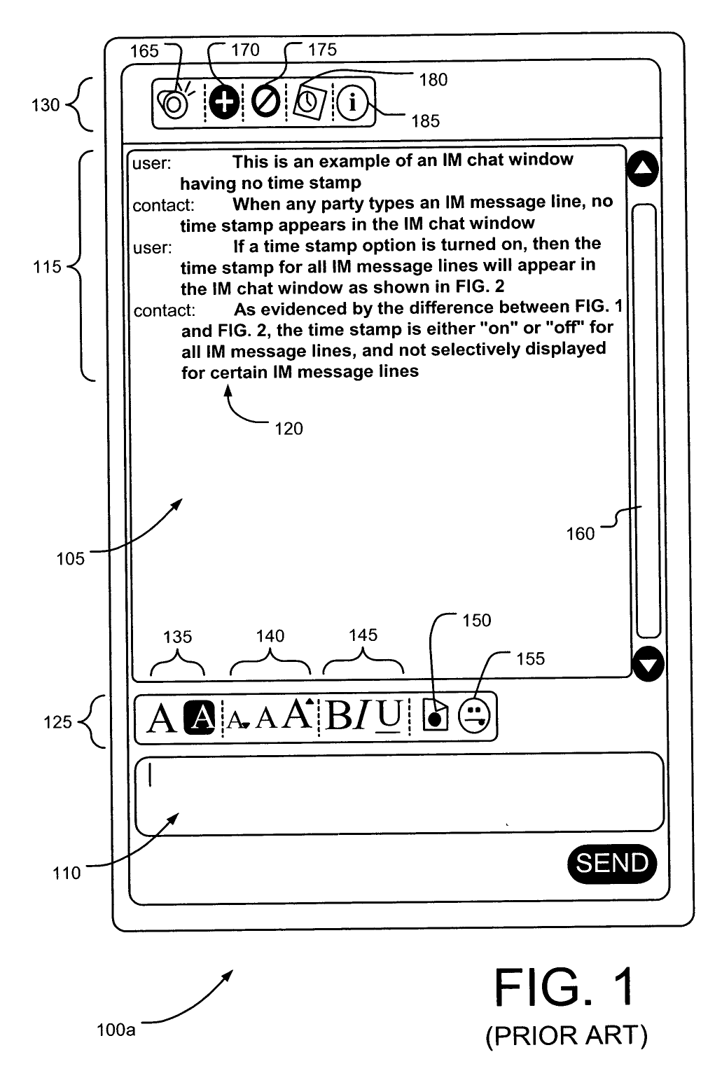

FIG. 7 is a block diagram showing an embodiment of a system configured to generate the IM chat windows of FIGS. 1 through 6. As shown in FIG. 7, an embodiment of the system may comprise a user client workstation 710a (also designated herein as “client workstation 1”) and a contact client workstation 710b (also designated herein as “client workstation 2”) that are both communicatively coupled to one or more pieces of server hardware 720a . . . 720b (also referred to herein as “servers”) on the Internet 730. The user client workstation 710a includes a user instant messaging (IM) client 715a, which permits the user to engage in IM communications over the Internet 730. Similarly, the contact client workstation 710b includes a contact IM client 715b, which permits the contact to also engage in IM communications over the Internet 730.

When the user chooses to send an IM message to a contact, the user may select a contact from a list of contacts (e.g., an address book, a “buddy list,” etc.) at the user IM client 715a. Alternatively, the user may type in contact information at an input box provided by the user IM client 715a. The selection of the contact (or entry of contact information) results in a validation of contact availability (e.g., correct IM address, correct domain, etc.) at the contact IM client 715b. Contact availability may be validated using conventionally known methods. Hence, further details related to the validation are omitted here. In some embodiments, the selection of the contact may include opening an IM chat window having a dialogue box, similar to that shown in FIGS. 3 through 6.

Upon opening the IM chat window, the transmitted and received IM messages, between the user and the contact, are displayed in the dialogue box in the IM chat window. However, unlike prior systems that either displayed a time stamp for all IM messages or no time stamp for any IM message, some embodiments of the system are configured to selectively display IM messages as a function of a triggering event. For example, one triggering event may be an initiation of an IM chat session. Hence, when the IM chat window is opened, the first IM message displayed in the dialogue box may include a time indication that displays the start time for the IM chat session. Another example of a triggering event may be a prolonged delay between IM messages. In other words, if a predetermined time elapses from the displaying of an IM message, the elapsing of that predetermined time may be a triggering event. For those embodiments, a time indication may be displayed next to the most-recently-displayed IM message to indicate the onset of inactivity. Yet another example of a triggering event may be continued activity after a period of inactivity. For example, when an IM chat session has been inactive (e.g., neither the user nor the contact has typed an IM message for a predetermined time period), a time indication may be displayed when activity resumes (e.g., either the user or the contact types an IM message after the predetermined time period) at the IM chat window. The time indication in these examples may include a visual delineator that visually depicts the time at which the triggering event occurred.

While FIG. 7 shows server-mediated IM communications between the user client workstation 710a and the contact client workstation 710b, it should be appreciated that direct IM communications between the IM clients 715a, 715b may occur in some embodiments of the invention.

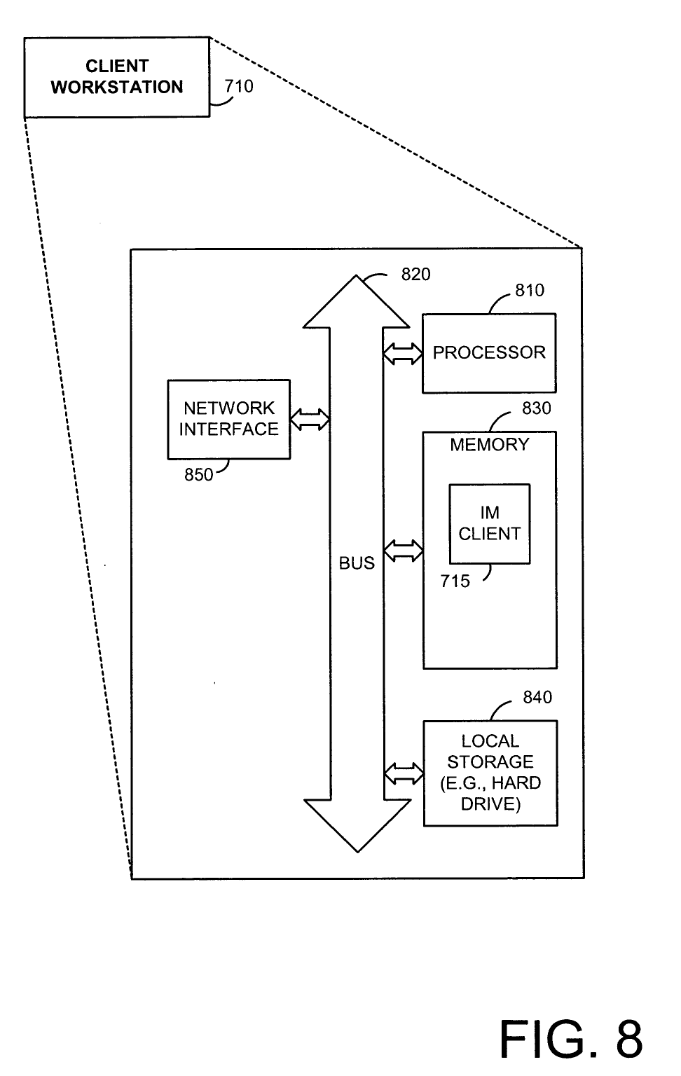

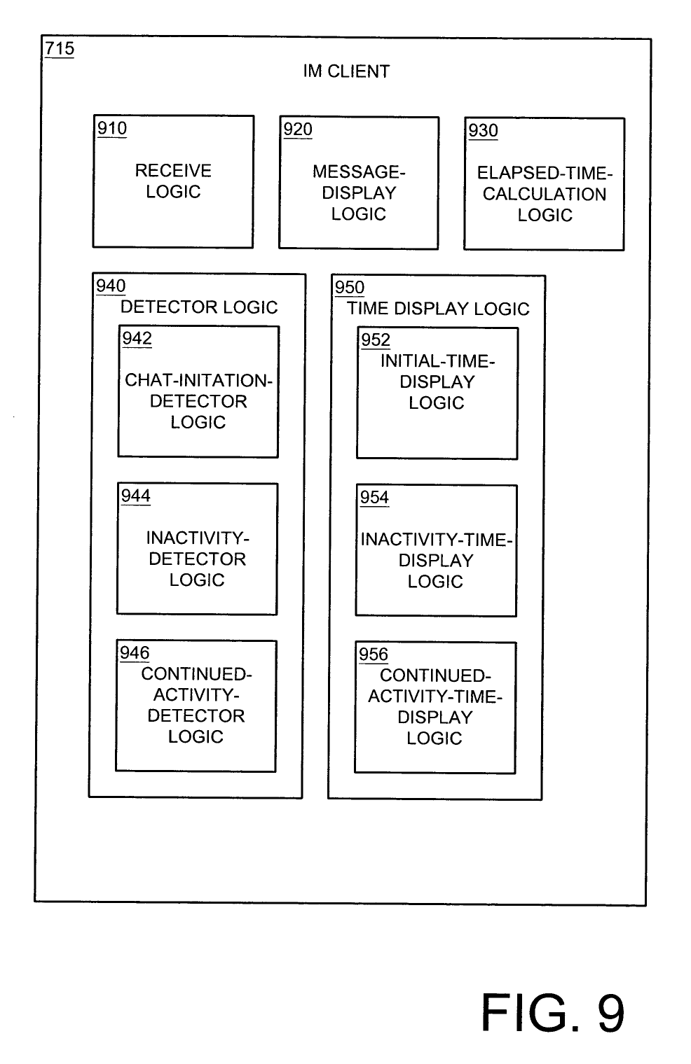

FIG. 8 is a block diagram showing an embodiment of component architecture associated with the system of FIG. 7. As shown in FIG. 8, the client workstation 710 comprises a system board that includes a processor 810, a network interface 850, a memory 830, a local storage device 840, and a bus 820 that permits communication between the various components. In one example, the local storage device 840 may be a hard drive configured to electronically store data. The local storage device 840 may also store computer programs that execute on the client workstation 710. In this sense, the processor 810 is configured to access any program that is stored on the local storage device 840, and execute the program with the assistance of the memory 830. As shown in FIG. 8, the memory 830, in one embodiment, includes an IM client 715 that permits IM communications. Various logic components associated with the IM client 715 are shown in greater detail in FIG. 9. Since the functioning of computing devices is well known in the art, further discussion of the processor 810, the memory 830, and the local storage device 840 are omitted here. While the various components are shown as residing on a single system board, it will be clear to one of ordinary skill in the art that the various components may reside at different locations, so long as they are coupled to each other to allow communication between the components.

The network interface 850 of FIG. 8 is configured to provide an interface between the client workstation 710 and the server hardware 720. Thus, the network interface 850 provides the interface for the client workstation 710 to receive any data that may be entering from the server hardware 720 and, also, to transmit any data from the client workstation 710 to the server hardware 720. In this regard, the network interface 850 may be a modem, a network card, or any other interface that interfaces the client workstation 710 to a network.

FIG. 9 is a block diagram showing, in greater detail, an embodiment of the IM client 715 of FIGS. 7 and 8. As shown in FIG. 9, some embodiments of IM clients include receive logic 910, message-display logic 920, elapsed-time-calculation logic 930, detector logic 940, and time-display logic 950.

The receive logic 910 is configured to receive IM messages. In this regard, the receive logic 910 may receive an IM message as it is typed by a user at a workstation or, alternatively, the receive logic 910 may receive an IM message that has been transmitted from a contact IM client. Regardless of the origin of the IM message, the receive logic 910 is configured to receive the IM message.

The message-display logic 920 is configured to display the IM message once the IM message has been received. In some embodiments, the IM message is displayed in a dialogue box in an IM chat window similar to that shown in FIGS. 3 through 6.

The elapsed-time-calculation logic 930 is configured to track elapsed time associated with the IM message. In some embodiments, the elapsed time may be tracked from the time of receiving the IM message. In other embodiments, the elapsed time may be tracked from the time of displaying the IM message. Often, the receiving of the IM message and the displaying of the IM message occur substantially simultaneously. In other words, there is often very little delay between the receiving of the IM message and the displaying of the IM message. Hence, the elapsed time will be approximately the same, regardless of whether the time is tracked from the receiving of the IM message or the displaying of the IM message.

The detector logic 940 is configured to detect a triggering event. In some embodiments, the detector logic 940 detects an initiation of an IM chat session. In this regard, the detector logic 940 may be seen as comprising chat-initiation-detector logic 942. The chat-initiation-detector logic 942 may detect the initiation of an IM chat session by detecting an initial IM message from a contact or, alternatively, detecting an initial IM message sent to a contact by a user.

In other embodiments, the detector logic 940 may be configured to detect inactivity at an IM chat window. For those embodiments, the detector logic 940 may be seen as comprising inactivity-detector logic 944. The inactivity-detector logic 944 may detect inactivity as a function of the elapsed time, which is determined by the elapsed-time-calculation logic 930.

In other embodiments, the detector logic 940 may be configured to detect continued activity at an IM chat window after a predefined period of inactivity. In that regard, the detector logic 940 may be seen as comprising continued-activity-detector logic 946, which detects the continued activity as a function of the elapsed time. Again, the elapsed time may be calculated using the elapsed-time-calculation logic 930.

The time-display logic 950 is configured to display the time associated with the triggering event. For some embodiments, the time may be displayed with a visual delineator that marks the triggering event. For other embodiments, the time may be displayed without an additional visual delineator. For yet other embodiments, only a visual delineator may be displayed in the IM chat window.

In some embodiments, the triggering event may be the initiation of an IM chat session. Thus, the displayed time may be an IM chat session start time. In this regard, the time-display logic 950 may be seen as comprising initial-time-display logic 952, which displays the start time, when the initiation of the IM chat session is detected by the chat-initiation-detector logic 942. As described above, the IM chat session may be initiated by either the user (e.g., sending an IM message) or the contact (e.g., receiving an IM message).

In other embodiments, the time-display logic 950 may include an inactivity-time-display logic 954, which is configured to display the time of onset of inactivity. In other words, when the inactivity-detector logic 944 detects inactivity at the IM chat window, the inactivity-time-display logic 954 displays the time at which there was onset of inactivity.

In yet other embodiments, the time-display logic 950 may be configured to display continued activity after a period of inactivity. Hence, the time-display logic 950 may include continued-activity-time-display logic 956, which displays a time indicative of the onset of activity at an IM chat window. For those embodiments, when the continued-activity-detector logic 946 detects the onset of continued activity (e.g., an IM message typed by the user, an IM message received from a contact, status change of an IM contact, etc.), the continued-activity-time-display logic 956 displays the time associated with the onset of continued IM activity.

As shown in the embodiment of FIG. 9, the detector logic 940, the elapsed-time-calculation logic 930, and the time-display logic 950 work in conjunction to selectively display time indications in an IM chat window. Hence, unlike prior approaches, only those times that are triggered by certain predefined events are displayed to the user. The selective displaying of the time indications results in a less cluttered visual environment. Additionally, the selective displaying of the time indications provides for automatic time stamping in response to certain triggering events, rather than requiring a manual toggling of IM time stamping functions.

FIG. 10 is a flowchart showing an embodiment of a method for selectively displaying time indications for specific IM message lines. As shown in FIG. 10, some embodiments of the method begin when an IM message is received (1005). Upon receiving (1005) the IM message, an IM chat window is opened (1010). The IM chat window, in some embodiments, includes a dialogue box and a status area, similar to those shown in FIG. 3. Upon opening (1010) the IM chat window, a time associated with the IM message is determined (1015). Thereafter, the IM message is displayed (1020) in the IM dialogue box, while the time associated with the IM message is displayed (1025) in the status area. Upon displaying (1020, 1025) the IM message and the time, the system determines (1030) whether or not the IM chat session has terminated. If the IM chat session has terminated, then the process of FIG. 10 ends. If, on the other hand, the IM chat session has not terminated, then the next IM message is received (1035), and a time associated with the newly-received IM message is determined (1015). Thereafter the IM message is displayed (1020) in the dialogue box, while the time is displayed (1025) in the status area. As shown in the embodiment of FIG. 10, the time in the status area is overwritten to reflect the latest IM message. In this regard, the status bar displays the time associated with only the most-recently-displayed IM message.

As shown in FIG. 10, by providing an IM time indication for only the most-recently-displayed IM message, much of the visual clutter is eliminated.

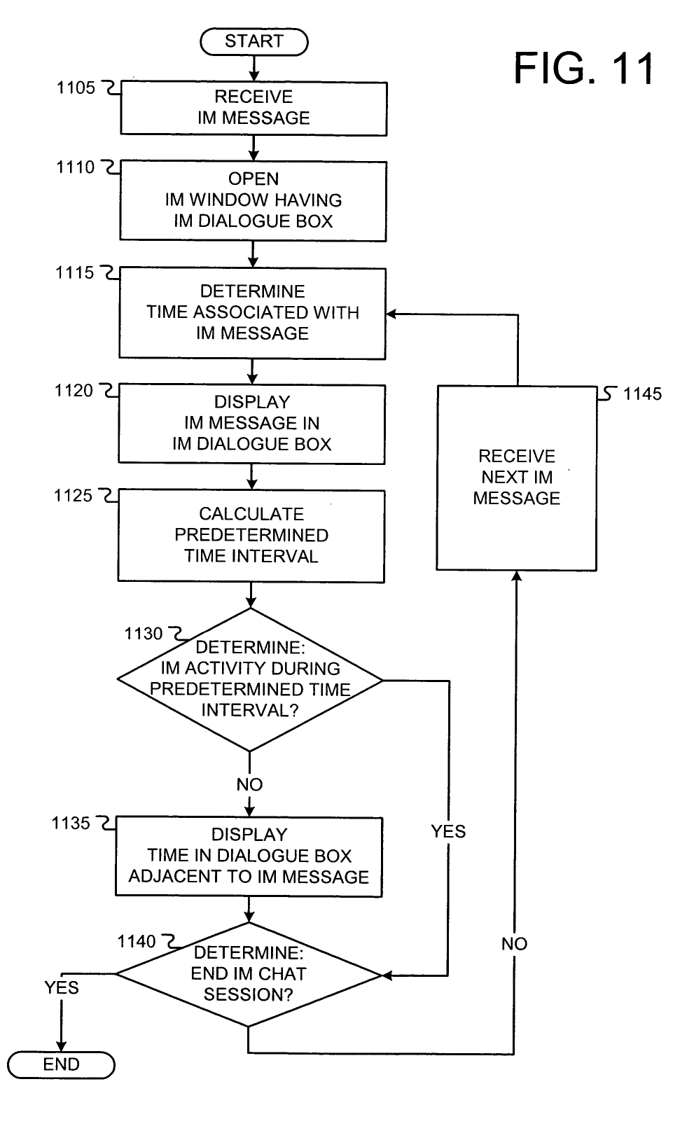

FIG. 11 is a flowchart showing another embodiment of a method for selectively displaying time indications for specific IM message lines. As shown in FIG. 11, some embodiments of the method begin when an IM message is received (1105). Upon receiving (1105) the IM message, an IM chat window is opened (1110). The IM chat window, in some embodiments, includes a dialogue box, similar to that shown in FIG. 4. Upon opening (1110) the IM chat window, a time associated with the IM message is determined (1115). Thereafter, the IM message is displayed (1120) in the IM dialogue box. Upon displaying (1120) the IM message, the system calculates (1125) a predetermined time interval. For some embodiments, the predetermined time interval is indicative of a time of inactivity. Hence, the calculating (1125) of the predetermined time interval may be seen as the tracking of an elapsed time. The predetermined time interval may be a default time period (e.g., set to five minutes by the system) or a user-settable time period (e.g., variably set by the user). During the predetermined time period, the system determines (1130) whether or not there is any IM activity. In other words, the system determines (1130) whether or not the system is inactive for a predetermined time interval. If there is inactivity during the predetermined time interval, then the system displays (1135) a time in the dialogue box. The displayed time is indicative of the onset of inactivity and, in some embodiments, may be displayed adjacent to the most-recently-displayed IM message.

If, however, there is IM activity during the predetermined time interval, then the system further determines (1140) whether or not the IM chat session has terminated. If the IM chat session has terminated, then the process of FIG. 11 ends. If, on the other hand, the IM chat session has not terminated, then the next IM message is received (1145), and the process repeats by determining (1115) the time associated with the newly-received IM message.

As shown in FIG. 11, by displaying a time indication associated with inactivity, a user may readily track periods of IM inactivity within an IM chat session.

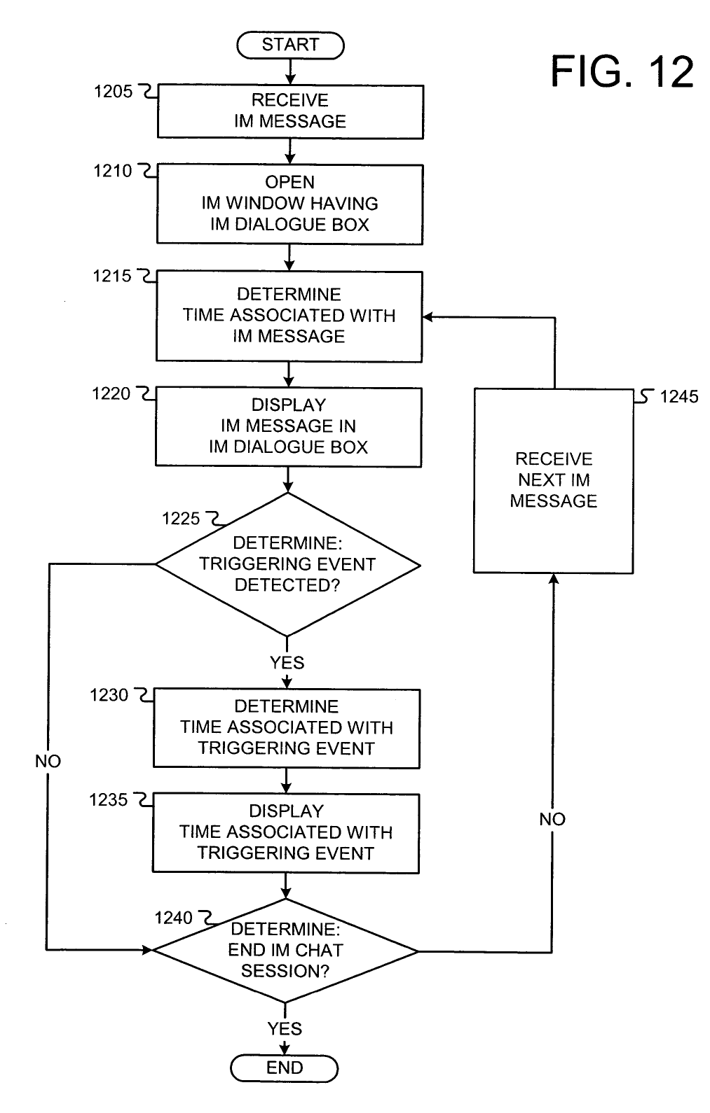

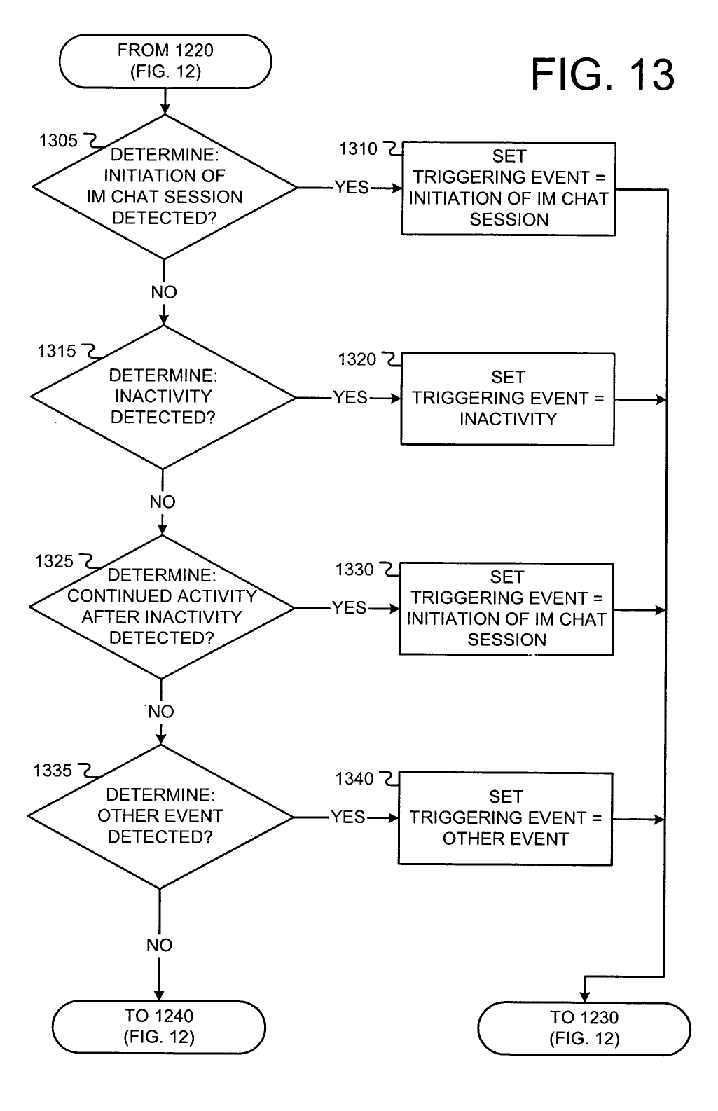

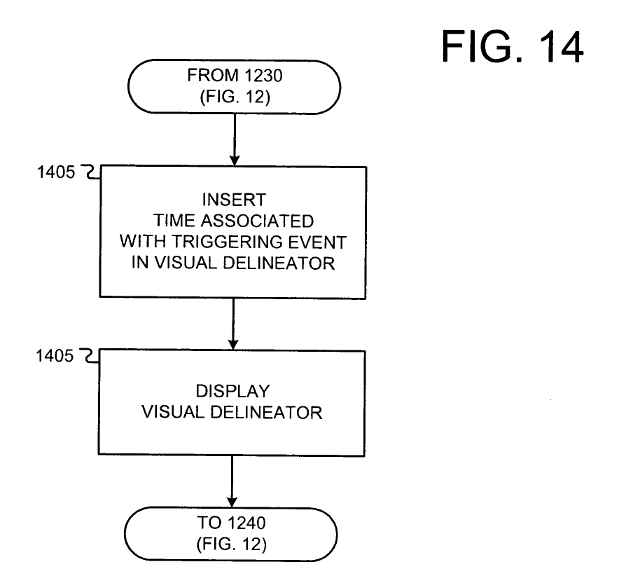

FIG. 12 is a flowchart showing yet another embodiment of a method for selectively displaying time indications for specific IM message lines. As shown in FIG. 12, some embodiments of the method begin when an IM message is received (1205). Upon receiving (1205) the IM message, an IM chat window is opened (1210). The IM chat window, in some embodiments, includes a dialogue box, similar to that shown in FIG. 5 or 6. Upon opening (1210) the IM chat window, a time associated with the IM message is determined (1215). Thereafter, the IM message is displayed (1220) in the IM dialogue box. Upon displaying (1220) the IM message, the system determines (1225) whether or not a triggering event has been detected. Some embodiments of triggering events are described with reference to FIG. 13. If a triggering event has been detected, then the system determines (1230) a time associated with the triggering event, and displays (1235) the time associated with the triggering event. An embodiment of the displaying (1235) of the time associated with the triggering event is shown in greater detail with reference to FIG. 14.

If, however, a triggering event has not been detected, then the system further determines (1240) whether or not the IM chat session has terminated. If the IM chat session has terminated, then the process of FIG. 12 ends. If, on the other hand, the IM chat session has not terminated, then the next IM message is received (1245), and the process repeats by determining (1215) the time associated with the newly-received IM message.

As shown in FIG. 12, by displaying time indications as a function of triggering events, the IM user need not manually activate or deactivate IM time-stamping functions of an IM client. Rather, the IM time-stamping function is automatically toggled on or off as a function of the triggering event, thereby reducing visual clutter and simplifying IM operation by the user.

FIG. 13 is a flowchart showing, in greater detail, the step of determining (1225) the existence of a triggering event from FIG. 12. As shown in FIG. 12, a detection of a triggering event may be determined (1225) by determining (1305) whether or not an initiation of an IM chat session has been detected. If initiation of an IM chat session has been detected, then the system sets (1310) a flag to indicate that the triggering event is the initiation of an IM chat session. Thereafter, the process continues to the time determining step (1230) of FIG. 12.

If an initiation of an IM chat session is not detected, then the system determines (1315) whether or not inactivity at the IM chat window has been detected. If inactivity has been detected, then the system sets (1320) a flag to indicate that the triggering event is inactivity at the IM chat window. Thereafter, the process continues to the time determining step (1230) of FIG. 12.

If neither an initiation of an IM chat session nor inactivity is not detected, then the system determines (1325) whether or not continued activity, after a prolonged period of inactivity (e.g., five minutes of inactivity, or a predefined time interval of inactivity) at the IM chat window, has been detected. If continued activity has been detected, then the system sets (1330) a flag to indicate that the triggering event is continued activity at the IM chat window. Thereafter, the process continues to the time determining step (1230) of FIG. 12.

If none of the above-mentioned triggering events has been detected, the system may determine (1335) whether or not other events have been detected. The other events may include a change in a contact's IM status (e.g., away, busy, extended away, logout, etc.). If one or more other events have been detected, then the system sets (1340) a flag indicative of the other triggering event. Thereafter, the process continues to the time determining step (1230) of FIG. 12.

If, on the other hand, no triggering event occurs, then the process continues to step 1240 to determine whether or not the IM chat session has terminated. While several embodiments of triggering events have been described, it should be appreciated that the triggering event may be custom-tailored according to various desires of the end user.

FIG. 14 is a flowchart showing, in greater detail, the step of displaying (1235) the time associated with the triggering event of FIG. 12. In some embodiments, the displaying step (1235) may include the step of inserting (1405) the time associated with the triggering event in a visual delineator. The visual delineator may, in some embodiments, appear similar to that shown in FIG. 5 or 6. Upon inserting (1405) the time in the visual delineator, the system displays (1405) the visual delineator, along with the inserted time, in the dialogue box. In some embodiments, the resulting visual display may be similar to that shown in FIG. 5 or 6.

It should be appreciated that, while not explicitly described, other embodiments of the process may include combinations of the method steps provided in FIGS. 10 through 14. For example, as described with reference to FIGS. 5 and 6, the most-recently-displayed IM time indication in FIG. 10 may be combined with the displaying of the triggering events as described in FIG. 12. Similarly, other features of the various embodiments may be combined in various permutations, as should be appreciated by one of ordinary skill in the art.

As shown in the embodiments of FIGS. 10 through 14, unlike prior approaches, only those times that are triggered by certain predefined events are displayed to the user. The selective displaying of the time indications results in a less cluttered visual environment. Additionally, the selective displaying of the time indications provides for automatic time stamping in response to certain triggering events, rather than requiring a manual toggling on or off of IM time stamping functions.

The IM client 715, the receive logic 910, the message-display logic 920, the elapsed-time-calculation logic 930, the detector logic 940, the chat-initiation-detector logic 942, the inactivity-detector logic 944, the continued-activity-detector logic 946, the time-display logic 950, the initial-time-display logic 952, the inactivity-time-display logic 954, the continued-activity-time-display logic 956, and other logic components configured to perform the functions described with reference to the various embodiments of the present invention can be implemented in hardware, software, firmware, or a combination thereof. In the preferred embodiment(s), the IM client 715, the receive logic 910, the message-display logic 920, the elapsed-time-calculation logic 930, the detector logic 940, the chat-initiation-detector logic 942, the inactivity-detector logic 944, the continued-activity-detector logic 946, the time-display logic 950, the initial-time-display logic 952, the inactivity-time-display logic 954, and the continued-activity-time-display logic 956 are implemented in software or firmware that is stored in a memory and that is executed by a suitable instruction execution system. If implemented in hardware, as in an alternative embodiment, the IM client 715, the receive logic 910, the message-display logic 920, the elapsed-time-calculation logic 930, the detector logic 940, the chat-initiation-detector logic 942, the inactivity-detector logic 944, the continued-activity-detector logic 946, the time-display logic 950, the initial-time-display logic 952, the inactivity-time-display logic 954, and the continued-activity-time-display logic 956 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The IM client 715 (and its related functions) may be implemented as a computer program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations may be made, none of which depart from the spirit of the present invention. For example, while isolated systems and devices have been shown to implement the various aspects of the invention, it should be understood that the method steps may be performed in a distributed network in which various distributed components perform the various functions. In this regard, the system may be seen as either an isolated system or a distributed network that encompasses the various components described above. Also, while various triggering events have been described with specificity, it should be appreciated that the triggering events are not limited to those specifically disclosed herein. Rather, the triggering event may be any detectable IM-related event.

All such changes, modifications, and alterations should therefore be seen as within the scope of the present invention.

1. A communication method comprising the steps of:
displaying instant messaging (IM) messages; and
selectively displaying a time indication, the time indication being indicative of a most-recently-displayed IM message.

2. The method of claim 1, wherein the step of displaying the IM messages comprises the steps of:
providing an IM dialogue box within an IM chat window; and
displaying the IM messages within the IM dialogue box.

3. The method of claim 2, wherein the step of selectively displaying the time indication comprises the step of:
selectively displaying the time indication in the IM dialogue box, the time indication being displayed adjacent to the most-recently-displayed IM message, the time indication being displayed in response to a triggering event.

4. The method of claim 1, wherein the step of selectively displaying the time indication comprises the steps of:
providing a status area within an IM chat window; and
selectively displaying the time indication in the status area.

5. A communication method comprising the steps of:
displaying a first instant messaging (IM) message;
calculating an elapsed time from the displaying of the first IM message;
determining whether a second IM message has been displayed within the elapsed time;
displaying a first time indication, the first time indication being associated with the first IM message, the first time indication being displayed in response to determining that the second IM message has not been displayed within the elapsed time.

6. The method of claim 5, wherein the step of displaying the first IM message comprises the step of:
providing an IM dialogue box within an IM chat window; and
displaying the first IM message within the IM dialogue box.

7. The method of claim 6, wherein the step of displaying the first time indication comprises the step of:
displaying the first time indication in the IM dialogue box.

8. The method of claim 5, wherein the step of displaying the first time indication comprises the step of:
displaying a first visual delineator after the first IM message, the first visual delineator having a time associated with the first IM message.

9. The method of claim 5, further comprising the steps of:
displaying a second IM message after the elapsed time;
displaying a second time indication, the second time indication being associated with the second IM message, the second time indication being indicative of the elapsed time between the first IM message and the second IM message.

10. The method of claim 9, wherein the step of displaying the second time indication comprises the step of:
displaying a second visual delineator before the second IM message, the second visual delineator having a time associated with the second IM message.

11. The method of claim 10, wherein the step of displaying the second visual delineator comprises the steps of:
providing an IM dialogue box within an IM chat window; and
displaying the second visual delineator in the IM dialogue box.

12. The method of claim 11, further comprising the steps of:
providing a status area within the IM chat window, the status area being distinct from the IM dialogue box; and
selectively displaying a most-recently-displayed IM time in the IM dialogue box, the most-recently-displayed IM time being associated with the most-recently-displayed IM message.

13. A communication method comprising the steps of:
detecting a triggering event associated with an instant messaging (IM) chat session; and
displaying a visual indicator in response to the triggering event.

14. The method of claim 13, wherein the step of detecting the triggering event comprises a step selected from the group consisting of:
detecting an initiation of a chat session;
detecting a predefined period of inactivity; and
detecting continued activity after a predefined period of inactivity.

15. The method of claim 14, wherein the step of displaying the visual indicator comprises the step of:
displaying an initial IM time indication, the initial IM time indication being indicative of a start time of the IM chat session.

16. The method of claim 14, wherein the step of displaying the visual indicator comprises the step of:
displaying an inactivity IM time indication, the inactivity IM time indication being indicative of an onset of inactivity during the IM chat session.

17. The method of claim 14, wherein the step of displaying the time indication comprises the step of:
displaying a continued-activity IM time indication, the continued-activity IM time indication being indicative of a time at which the IM chat session continues after an onset of inactivity.

18. A computer-readable medium comprising:
computer-readable code adapted to instruct a programmable device to display instant messaging (IM) messages; and
computer-readable code adapted to instruct a programmable device to selectively display a time indication, the time indication being indicative of a most-recently-displayed IM message.

19. The computer-readable medium of claim 18, further comprising:
computer-readable code adapted to instruct a programmable device to provide a status area within an IM chat window; and
computer-readable code adapted to instruct a programmable device to selectively display the time indication in the status area.

20. A computer-readable medium comprising:
computer-readable code adapted to instruct a programmable device to display a first instant messaging (IM) message;
computer-readable code adapted to instruct a programmable device to calculate an elapsed time from the computer-readable code adapted to instruct a programmable device to display of the first IM message;
computer-readable code adapted to instruct a programmable device to determine whether a second IM message has been displayed within the elapsed time;
computer-readable code adapted to instruct a programmable device to display a first time indication, the first time indication being associated with the first IM message, the first time indication being displayed in response to computer-readable code adapted to instruct a programmable device to determine that the second IM message has not been displayed within the elapsed time.

21. The computer-readable medium of claim 20, further comprising:
computer-readable code adapted to instruct a programmable device to provide an IM dialogue box within an IM chat window; and
computer-readable code adapted to instruct a programmable device to display the first IM message within the IM dialogue box.

22. The computer-readable medium of claim 21, further comprising:
computer-readable code adapted to instruct a programmable device to display the first time indication in the IM dialogue box.

23. The computer-readable medium of claim 20, further comprising:
computer-readable code adapted to instruct a programmable device to display a first visual delineator after the first IM message, the first visual delineator having a time associated with the first IM message.

24. The computer-readable medium of claim 20, further comprising:
computer-readable code adapted to instruct a programmable device to display a second IM message after the elapsed time;
computer-readable code adapted to instruct a programmable device to display a second time indication, the second time indication being associated with the second IM message, the second time indication being indicative of the elapsed time between the first IM message and the second IM message.

25. The computer-readable medium of claim 24, further comprising:
computer-readable code adapted to instruct a programmable device to display a second visual delineator before the second IM message, the second visual delineator having a time associated with the second IM message.

26. The computer-readable medium of claim 25, further comprising:
computer-readable code adapted to instruct a programmable device to provide an IM dialogue box within an IM chat window; and
computer-readable code adapted to instruct a programmable device to display the second visual delineator in the IM dialogue box.

27. The computer-readable medium of claim 26, further comprising:
computer-readable code adapted to instruct a programmable device to provide a status area within the IM chat window, the status area being distinct from the IM dialogue box; and
computer-readable code adapted to instruct a programmable device to selectively display a most-recently-displayed IM time in the IM dialogue box, the most-recently-displayed IM time being associated with the most-recently-displayed IM message.

28. A computer-readable medium comprising:
computer-readable code adapted to instruct a programmable device to detect a triggering event associated with an instant messaging (IM) chat session; and
computer-readable code adapted to instruct a programmable device to display a visual indicator in response to the triggering event.

29. The computer-readable medium of claim 28, further comprising:
computer-readable code adapted to instruct a programmable device to detect an initiation of a chat session.

30. The computer-readable medium of claim 29, further comprising:
computer-readable code adapted to instruct a programmable device to display an initial IM time indication, the initial IM time indication being indicative of a start time of the IM chat session.

31. The computer-readable medium of claim 28, further comprising:
computer-readable code adapted to instruct a programmable device to detect a predefined period of inactivity.

32. The computer-readable medium of claim 31, further comprising:
computer-readable code adapted to instruct a programmable device to display an inactivity IM time indication, the inactivity IM time indication being indicative of an onset of inactivity during the IM chat session.

33. The computer-readable medium of claim 28, further comprising:
computer-readable code adapted to instruct a programmable device to detect continued activity after a predefined period of inactivity.

34. The computer-readable medium of claim 33, further comprising:
computer-readable code adapted to instruct a programmable device to display a continued-activity IM time indication, the continued-activity IM time indication being indicative of a time at which the IM chat session continues after an onset of inactivity.

35. The computer-readable medium of claim 29, further comprising:
computer-readable code adapted to instruct a programmable device to display an inactivity IM time indication, the inactivity IM time indication being indicative of an onset of inactivity during the IM chat session.

36. The computer-readable medium of claim 29, further comprising:
computer-readable code adapted to instruct a programmable device to display a continued-activity IM time indication, the continued-activity IM time indication being indicative of a time at which the IM chat session continues after an onset of inactivity.

37. A communication system comprising:
message-display logic configured to display instant messaging (IM) messages; and
time-display logic configured to selectively display a time indication, the time indication being indicative of a most-recently-displayed IM message.

38. A communication system comprising:
message-display logic configured to display a first instant messaging (IM) message;
time-calculation logic configured to calculate an elapsed time from the display of the first IM message;
determination logic configured to determine whether a second IM message has been displayed within the elapsed time;
time-display logic configured to display a first time indication, the first time indication being associated with the first IM message, the first time indication being displayed in response to determine that the second IM message has not been displayed within the elapsed time.

39. A communication system comprising:
detector logic configured to detect a triggering event associated with an instant messaging (IM) chat session; and
display logic configured to display a visual indicator in response to the triggering event.

40. The method of claim 39, wherein the detector logic comprises:
means for detecting an initiation of a chat session;
means for detecting a predefined period of inactivity; and
means for detecting continued activity after a predefined period of inactivity.

41. The method of claim 40, wherein the display logic comprises:
initial-time-display logic configured to display an initial IM time indication, the initial IM time indication being indicative of a start time of the IM chat session.

42. The method of claim 40, wherein the display logic comprises:
inactivity-time-display logic configured to display an inactivity IM time indication, the inactivity IM time indication being indicative of an onset of inactivity during the IM chat session.

43. The method of claim 40, wherein the display logic comprises:
continued-activity-time-display logic configured to display a continued-activity IM time indication, the continued-activity IM time indication being indicative of a time at which the IM chat session continues after an onset of inactivity.
